(19) United States
(12) Patent Application Publication
(10) Pub. No.: US 2015/0240099 A1
(43) Pub. Date: Aug. 27, 2015

(54) SILVER FLAKE CONDUCTIVE PASTE INK WITH NICKEL PARTICLES

(71) Applicant: XEROX CORPORATION, NORWALK, CT (US)

(72) Inventors: Naveen Chopra, Oakville (CA); Gabriel Iftime, Mississauga (CA); Yilliang Wu, Oakville (CA); Sandra Gardner, Oakville (CA)

(73) Assignee: XEROX CORPORATION, NORWALK, CT (US)

(21) Appl. No.: 14/188,222

(22) Filed: Feb. 24, 2014

(51) Int. Cl. C09D 11/00

(52) U.S. Cl. CPC C09D 11/52

(57) ABSTRACT

A silver flake conductive paste ink includes a silver flake conductive material; non-compressible, conductive particles having a rough morphology; a binder; and a solvent. The conductive paste ink is suitable for screen printing with lower cost and improved conductivity and lower resistivity as compared with conventional conductive inks.

### TECHNICAL FIELD

This disclosure is generally directed to a conductive paste ink. More specifically, this disclosure is directed to a conductive paste ink including silver flakes and nickel particles, and methods for producing such conductive paste inks.

### BACKGROUND

Screen-printing is the method of choice for printing conductive ink traces for applications such as photovoltaic cells, RFID antennas, and flexible electrical interconnects for high-value commodities such as hospital bed monitors/controls and military GPS units. Conductive paste inks are typically formulated with a polymer binder system, solvent, and metal particles, such as silver (Ag), to provide conductivity. Conductive paste inks have high loadings of Ag (>60% weight) to compensate for the high density and to ensure intimate flake-to-flake contact for reducing resistivity. The high amount of silver increases the cost of such conductive paste inks.

Many efforts are underway worldwide to reduce the cost of conductive paste inks. One approach is to replace the Ag particles with cheaper metals such as copper (Cu). A drawback of using Cu is the extreme tendency of Cu to form non-conductive oxides.

There remains a need to reduce the Ag content of conductive paste inks to enable more cost-effective conductive paste inks.

### SUMMARY

The following detailed description is of the best currently contemplated modes of carrying out exemplary embodiments herein. The description is not to be taken in a limiting sense, but is made merely for the purpose of illustrating the general principles of the disclosure herein, since the scope of the disclosure herein is best defined by the appended claims.

Various inventive features are described below that can each be used independently of one another or in combination with other features.

Broadly, embodiments of the disclosure herein generally provide a silver flake conductive paste ink including a silver flake conductive material; non-compressible, conductive particles having a rough morphology; a binder; and a solvent.

In another aspect of the disclosure herein, a silver conductive paste ink includes a silver conductive material, nickel particles, a binder, and a solvent.

In yet another aspect of the disclosure herein, a silver flake conductive paste ink includes silver flakes, nickel particles, a binder, and a solvent.

### BRIEF DESCRIPTION OF THE FIGURES

Various embodiments of the present disclosure will be described herein below with reference to the following figures wherein:

FIG. 1 illustrates a caricature of a conductive paste ink according to exemplary embodiments herein;

FIG. 2A illustrates a scanning electron microscope image (SEM image) of a cured ink film using a conductive paste ink according to the present disclosure;

FIG. 2B illustrates a SEM image of a cured ink film using a control conductive paste ink;

FIG. 3A illustrates a cross section view of an energy dispersive spectrometry image (EDS image) of the cured ink film of FIG. 2A; and

FIG. 3B illustrates a side view of an EDS image of a cured ink film of FIG. 2A showing the nickel particles.

### DETAILED DESCRIPTION

In the present disclosure, the terms “a,” “an,” and “the” include plural forms unless the content clearly dictates otherwise.

In the present disclosure, ranges disclosed herein include, unless specifically indicated, all endpoints and intermediate values.

In the present disclosure, the term “optional” or “optionally” refer, for example, to instances in which subsequently described circumstances may or may not occur, and include instances in which the circumstance occurs and instances in which the circumstance does not occur.

In the present disclosure, the phrases “one or more” and “at least one” refer, for example, to instances in which one of the subsequently described circumstances occurs, and to instances in which more than one of the subsequently described circumstances occurs.

In the present disclosure, the term “about” used in connection with a quantity is inclusive of the stated value and has the meaning dictated by the context (for example, it includes at least the degree of error associated with the measurement of the particular quantity). When used in the context of a range, the term “about” should also be considered as disclosing the range defined by the absolute values of the two endpoints. For example, the range “from about 2 to about 4” also discloses the range “from 2 to 4.”

In the present disclosure, the term “aspect ratio” refers to the proportional relationship between the width and the height of a shape.

In the present disclosure, the term “particle size distribution” refers to the median diameter or the medium value of the particle size distribution. For example, if the particle size distribution is 5.8 μm, then 50% of the particles in the sample are larger than 5.8 μm, and 50% smaller than 5.8 μm.

In the present disclosure, the term “printing” refers to any coating technique capable of forming a conductive ink paste composition into a desired pattern on a substrate. Examples of suitable techniques include, for example, spin coating, blade coating, rod coating, dip coating, lithography or offset printing, gravure, flexography, screen printing, stencil printing, and stamping (such as microcontact printing).

The present disclosure provides a conductive paste ink including a conductive material (such as silver) and non-compressible conductive particles (such as Ni) suitable for printing with lower cost, improved conductivity, and lower resistivity as compared to conventional conductive inks. The present disclosure also provides methods for producing such conductive inks.

The conductive paste ink herein may be made by any suitable method. One exemplary method is to dissolve a binder(s) in a solvent(s), which may be accompanied by heat and/or stirring. A conductive material, such as silver, may then be added to the mixture, desirably at a gradual rate of addition to avoid lumping. The conductive particles, such as Ni particles, may be added to the mixture. Heat and/or stirring may again be applied during the addition of the conductive material and/or the conductive particles.

The conductive paste ink can be used to form conductive features on a substrate by printing. The printing may be carried out by depositing the ink on a substrate using any suitable printing technique, for example, screen printing.

The substrate upon which the conductive paste ink is deposited may be any suitable substrate including, for example, silicon, glass plate, plastic film, sheet, fabric, or paper. For structurally flexible devices, plastic substrates such as polyester, polycarbonate, polyimide sheets and the like may be used.

Following printing, the patterned deposited conductive paste ink can be subjected to a curing step. The curing step can be a step in which substantially all of the solvent of the conductive paste ink is removed and the ink is firmly adhered to the substrate.

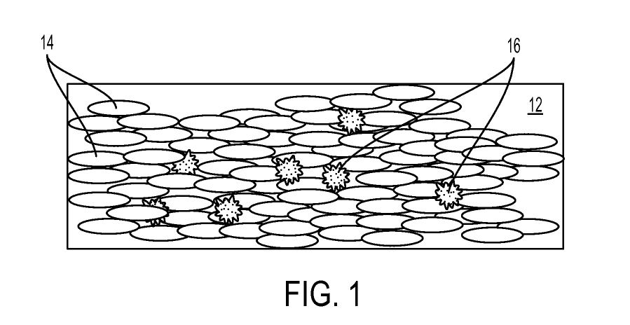

FIG. 1 illustrates a caricature of a conductive paste ink 10 according to exemplary embodiments herein. This caricature depiction, however, is not intended to limit the scope of the embodiments disclosed herein and is only presented for ease of understanding. The conductive paste ink 10 may comprise a mixture of a binder(s) 12, a solvent(s) (not shown), a conductive material 14, and non-compressible, conductive particles 16.

### Conductive Material(s)

The conductive material(s) may be, for example, elemental silver, a silver alloy, a silver compound, or combinations thereof. In embodiments, the conductive material may also be a base material coated or plated with pure silver, a silver alloy, or a silver compound, for example silver plated copper flakes.

Nonrestrictive examples of the silver compound herein include silver oxide, silver thiocyanate, silver cyanide, silver cyanate, silver carbonate, silver nitrate, silver nitrite, silver sulfate, silver phosphate, silver perchlorate, silver tetrafluoroborate, silver acetylacetonate, silver acetate, silver lactate, silver oxalate and derivatives thereof. The silver alloy may be formed from at least one metal selected from Au, Cu, Ni, Co, Pd, Pt, Ti, V, Mn, Fe, Cr, Zr, Nb, Mo, W, Ru, Cd, Ta, Re, Os, Ir, Al, Ga, Ge, In, Sn, Sb, Pb, Bi, Si, As, Hg, Sm, Eu, Th Mg, Ca, Sr and Ba, but not particularly limited to them.

The conductive material may have any shape. In embodiments, the conductive material may have a shape of, for example, a flake, a rod, a cone, a plate, or a needle. The shape may have, for example, an aspect ratio (i.e., width to height) of about 30 to about 1, or about 5 to about 1, or about 3 to about 1.

The conductive material may have an average particle size of, for example, from about 0.5 to about 15 microns, or from about 1 to about 10 microns, or from about 2 to about 10 microns.

The conductive material may be present in the conductive paste ink in an amount, for example, from about 50 to about 95 weight percent of the paste ink, or from about 60 to about 90 weight percent of the paste ink, or from about 70 to about 85 weight percent of the paste ink.

### Non-Compressible Conductive Particles

The conductive paste ink may also include a non-compressible (i.e., hard to compress) conductive particles having a rough morphology. The conductive particles may be, for example, nickel particles. The conductive particles may be used to substitute for some of the conductive material and thereby lower the overall cost of the conductive paste ink. The conductive particles can be mechanically stronger than the conductive material and may be used as a reinforcing agent to enhance the mechanical strength of the conductive material. Though not intended to limit the scope of the embodiments herein, the conductive particles may act as conductive points when pressed in contact with the conductive material, thereby acting as bridges between adjacent parts of the conductive material to create a conductive path throughout the conductive material.

In embodiments, the conductive particles, such as Ni, may be in the form of a powder having an average particle size, for example, from about 0.05 to about 10 microns, or from about 0.1 to about 7 microns, or from about 0.2 to about 5 microns.

In other embodiments, the conductive particles, such as Ni, may be present in different sizes with a particle size distribution of, for example, from about 100 nm to about 5 μm, or from about 50 nm to about 1 μm, or from about 25 nm to about 1 μm. This range of co-mixed particle size distribution may be unimodal (particles presenting one size distribution), bimodal (particles presenting two size distribution), or multi-modal (particles presenting several size distributions).

The conductive particles may have an irregular and slender shape, for example, a spike shape, a needle shape, a rice shape, a stick shape, a butterfly shape, or a bow tie shape. In certain embodiments, the conductive particles can have a spike-like morphology, as well as rough morphology. The irregular and slender shape of the conductive particles may help to ensure contact between the parts/surfaces of the conductive material.

The conductive particles, such as Ni, may be present in the conductive paste ink in an amount, for example, from about 0.1 to about 5.0 weight percent of the paste ink, or from about 0.5 to about 4.0 weight percent of the paste ink, or from about 1.0 to about 3.0 weight percent of the paste ink.

### Binder(s)

The conductive paste ink may also include at least one binder, such as a polymer binder. The polymer binder may have a high viscosity to allow the conductive paste ink to retain the pattern following printing. The binder, such as a polymer binder, may have a weight average molecular weight (Mw) of about 10,000 to about 600,000 Da, or from about 40,000 to about 300,000 Da, or from about 40,000 to about 250,000 Da.

The polymer binder may be, for example, a polyvinylbutyral (PVB) terpolymer; polyesters such as terephthalates, terpenes, styrene block; copolymers such as styrene-butadiene-styrene copolymer, styrene-isoprene-styrene copolymer, styrene-ethylene/butylene-styrene copolymer, and styrene-ethylene/propylene copolymer; ethylene-vinyl acetate copolymers; ethylene-vinyl acetate-maleic anhydride terpolymers; ethylene butyl acrylate copolymer; ethylene-acrylic acid copolymer; polymethylmethacrylate; polyethylmethacrylate; poly(alkyl)methacrylates; polyolefins; polybutene, polyamides; and mixtures thereof.

In embodiments, the polymer binder is a PVB terpolymer. Examples of PVB terpolymers include, for example, polymers manufactured by MOWITAL® (Kuraray America), S-LEC® (Sekisui Chemical Company), BUTVAR® (Solutia).

The binder(s), such as polymer binder(s), may be present in the conductive paste ink in an amount, for example, from about 0.1 to about 10.0 weight percent of the paste ink, or from about 0.5 to about 7.5 weight percent of the paste ink, or from about 1.0 to about 5.0 weight percent of the paste ink.

### Solvent(s)

The conductive paste ink can also include at least one solvent. The solvent may be a single solvent or a mixture of solvents. The solvent may be able to dissolve the polymer binder(s). Examples of suitable solvents include, for example, ethylene glycol; di-C1-C6-alkyl ethers; propylene glycol di-C1-C6-alkyl ethers; diethylene glycol di-C1-C6-alkyl ethers such as butyl carbitol (diethylene glycol monobutyl ether), dipropylene glycol di-CI-C6-alkyl ethers; or any combination thereof. In embodiments, the solvent is butyl carbitol.

The solvent(s) may be present in the conductive paste ink in an amount, for example, from about 5.0 to about 50.0 weight percent of the paste ink, or from about 5.0 to about 35.0 weight percent of the paste ink, or from about 5.0 to about 25.0 weight percent of the paste ink.

The conductive paste ink may contain optional additives such as, for example, a plasticizer, a lubricant, a dispersant, a leveling agent, a defoaming agent, an antistatic agent, an antioxidant and a chelating agent as necessary or desired.

### EXAMPLE

The following Example illustrates one exemplary embodiment of the present disclosure. This Example is intended to be illustrative only to show one of several methods of preparing the conductive ink and is not intended to limit the scope of the present disclosure. Also, parts and percentages are by weight unless otherwise indicated.

In this example, two sample inks were prepared using 2 to 5 micron silver flakes, binder and solvent. The two sample inks had the following compositions in Table 1.

TABLE 1

| | | Example#1 | | Example#2 | |
|---|---|---|---|---|---|
| | | (control) | | (5 wt % Ni particles) | |
| Component | Lot | Wt % | Grams | Wt % | Grams |
| Silver flakes | MR-10F | 75.00 | 50.03 | 70.00 | 46.69 |
| (2-5 microns) | (Inframat) | | | | |
| Ni Powder | Aldrich | — | — | 5.00 | 3.34 |
| 5 microns | | | | | |
| PVB | Butvar B- | 3.75 | 2.50 | 3.75 | 2.50 |
| | 98 | | | | |
| Butyl carbitol | Aldrich | 21.25 | 14.17 | 21.25 | 14.17 |
| Total | | 100.00 | 66.70 | 100.00 | 100.00 |

### Preparation of Conductive Paste Ink According to the Present Disclosure

### Example#1

### Control

A 15 wt % solution including 2.50 g of PVB in 14.17 g butyl carbitol was added to a 250 mL beaker equipped with a stainless steel anchor mixing blade. The mixture was stirred at 500 rpm at room temperature. Next, 50.03 g silver flakes were gradually added to the mixture in stages to avoid lumping. After 30 minutes of mixing, the ink paste was passed 3 times through a 3-roll-mill (Erweka model #AR 400). The finished paste ink was isolated and transferred to an amber glass jar.

### Example#2

### 5 wt % Ni Particles

A 15 wt % solution including 2.50 g of PVB in 14.17 g butyl carbitol was added to a 250 mL beaker equipped with a stainless steel anchor mixing blade. The mixture was stirred at 500 rpm at room temperature. Next, 46.69 g silver flakes were gradually added to the mixture in stages to avoid lumping. Then, 3.34 g Ni powder was added to the mixture. After 30 minutes of mixing, the ink paste was passed 3 times through a 3-roll-mill (Erweka model #AR 400). The finished paste ink was isolated and transferred to an amber glass jar.

### Ink Coating

The conductive paste inks were coated at room temperature using a drawdown square at 0.5, 1, and 2 mil wet thicknesses using a Gardco automated drawdown apparatus onto 2 mil Mylar films. The films were thermally cured at 120° C. for 30 minutes in a convection oven.

### SEM Images of Cured Ink Coating

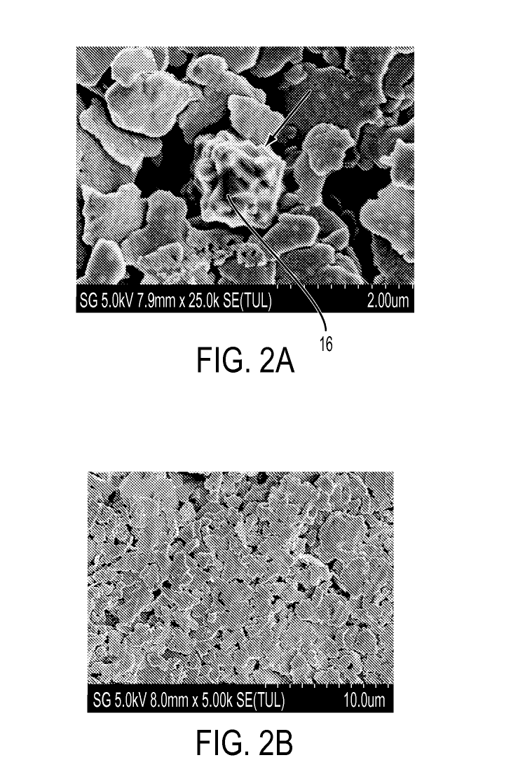

The samples were cut and mounted in the SEM. FIG. 2A is an SEM image of the cured ink film using the Example#2 conductive paste ink according to the present disclosure. FIG. 2B is an SEM image of a cured ink film using the Example#1 (control). As can be seen in FIG. 2A, the Ni particle is in the center of the image, with a rough spikey morphology. The silver flakes in FIG. 2A and FIG. 2B appear virtually the same, indicating that the Ni nanoparticles have not caused any disruption to the silver flake morphology.

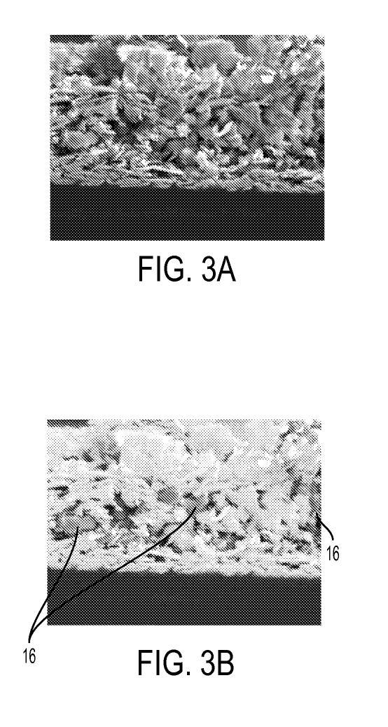

FIG. 3A illustrates a cross section view of an energy dispersive spectrometry image (EDS image) of the cured ink film of FIG. 2A. FIG. 3B illustrates a side view of an EDS image of a cured ink film of FIG. 2A showing the nickel particles.

### Resistivity Measurement

To measure conductivity of the deposited ink, a 2-point probe measurement was performed as follows: lines of about 200 mm length and about 2 mm width were cut into the film to test. Resistance was measured with a multimeter. Thickness of the deposit ink was measured in several places on the line and an average thickness was calculated. The sheet resistance is given by the following formula:

$$Sheet resistance [ \frac{\frac{Ω}{square}}{mil} ] = \frac{Resistance [ Ω ] * Thickness [ mils ]}{squares number [ dimensionless ]}$$

$$where \text{:}$$

$$Squares number = \frac{Length [ mm ]}{Width [ mm ]}$$

The sheet resistivity is specific to the ink. The lower the sheet resistance value, the better the conductivity. The goal is to minimize sheet resistance. Samples of the deposited inks were subjected to fusing. The fusing comprised pressing the deposited ink samples through a set of heated rollers. The rollers were heated at 130° C. for the experiments. The nip pressure was set to about 1000 psi. The top roll was made of steel while the other roll was rubber coated.

Table 2 shows the conductivity of each sample measured before fusing and after fusing. As can be seen from Table 2, after fusion the Example#2 film shows low resistivity values. This translates into improved conductivity. A decrease of 32% relative to the initial sheet resistance was measured for the Example#2 conductive paste ink. These changes are significant and consistent for the samples tested.

This process allows fabrication of silver conductive inks having very low sheet resistance, for example of 10 mΩ/sq./mil or less.

TABLE 2

| | | | | | | | Sheet | |
|---|---|---|---|---|---|---|---|---|
| | | | | | | | Resistance | |
| | | | | | | | (mΩ/square/mil)- | Avg Sheet |
| | | | | | | | Multimeter | Resistance |
| | | W | Thickness | Thickness | Resistance | | method | (mΩ/ |
| | L | (mm) | (microns) | (mils) | (Ω) | | Sheet | square/mil) |
| Sample # | (mm) | W | Thickness | Thickness | Resistance | Squares | Resistance | Avg Sheet |
| Sample # | L | (mm) | (microns) | (mils) | (Ω) | Squares | (mΩ/square/mil)- | Resistance |
| Example#2/ | 200 | 2.0 | 7.2 | 0.29 | 5.1 | 100 | 14.7 | 17.7 |
| 0.5 mil | 200 | 2.0 | 8.5 | 0.34 | 6.1 | 100 | 20.7 | |
| Example#2/ | 200 | 2.0 | 7.4 | 0.30 | 7.0 | 100 | 20.7 | 21.1 |
| 1 mil | 200 | 2.0 | 8.5 | 0.34 | 5.8 | 100 | 19.7 | |
| #1 Example#2/ | 200 | 2.0 | 11.7 | 0.47 | 4.0 | 100 | 18.7 | 18.2 |
| 1.5 mil | 200 | 2.0 | 11.1 | 0.44 | 4.3 | 100 | 19.1 | |
| | 100 | 2.0 | 11.0 | 0.44 | 1.9 | 50 | 16.7 | |
| #2 Example#2/ | 200 | 2.0 | 11.6 | 0.46 | 4.2 | 100 | 19.5 | 18.8 |
| 1.5 mil | 200 | 2.0 | 11.2 | 0.45 | 4.2 | 100 | 18.8 | |
| | 200 | 2.0 | 10.6 | 0.42 | 4.3 | 100 | 18.2 | |
| After Fusing- | 200 | 2.0 | 6.7 | 0.27 | 2.2 | 100 | 5.9 | 6.5 |
| Example#2 0.5 | 200 | 2.0 | 7.3 | 0.29 | 2.4 | 100 | 7.0 | |
| mil | | | | | | | | |
| After Fusing | 200 | 2.0 | 7.5 | 0.30 | 2.4 | 100 | 7.2 | 6.8 |
| AG-Example#2 | 200 | 2.0 | 7.4 | 0.30 | 2.0 | 100 | 5.9 | |
| 1 mil | 200 | 2.0 | 7.9 | 0.32 | 2.3 | 100 | 7.3 | |
| After Fusing - | 200 | 2.0 | 10.0 | 0.40 | 1.4 | 100 | 5.6 | 6.0 |
| #1 | 200 | 2.0 | 9.4 | 0.38 | 1.7 | 100 | 6.4 | |
| Example#2/1.5 | 100 | 2.0 | 9.4 | 0.38 | 0.8 | 50 | 6.0 | |
| mil | | | | | | | | |
| After Fusing - | 200 | 2.0 | 10.6 | 0.42 | 1.6 | 100 | 6.8 | 6.7 |
| #2 | 200 | 2.0 | 10.2 | 0.41 | 1.6 | 100 | 6.5 | |
| Example#2/1.5 | 200 | 2.0 | 10.0 | 0.40 | 1.7 | 100 | 6.8 | |
| mil | | | | | | | | |
| Example#1 | 200 | 2.0 | 4.2 | 0.17 | 5.9 | 100 | 9.9 | 10.6 |
| (control)/0.5 | 200 | 2.0 | 4.0 | 0.16 | 6.4 | 100 | 10.2 | |
| mil/ | 200 | 2.0 | 4.3 | 0.17 | 6.8 | 100 | 11.7 | |
| Example#1 | 200 | 2.0 | 5.5 | 0.22 | 4.4 | 100 | 9.7 | 10.9 |
| (control)/1 mil | 200 | 2.0 | 6.1 | 0.24 | 4.5 | 100 | 11.0 | |
| (CONTROL) | 200 | 2.0 | 6.2 | 0.25 | 4.8 | 100 | 11.9 | |

The resistivity of each sheet was recorded as mΩ/sq/mil.

It will be appreciated that variations of the above-disclosed and other features and functions, or alternatives thereof, may be desirably combined into many other different systems or applications. Also that various, presently unforeseen or unanticipated, alternatives, modifications, variations or improvements therein may be subsequently made by those skilled in the art which are also intended to be encompassed by the following claims.

What is claimed is:

1. A silver flake conductive paste ink, comprising:
a silver flake conductive material;
non-compressible, conductive particles having a rough morphology;
a binder; and
a solvent.

2. The conductive paste ink according to claim 1, wherein the conductive particles comprise nickel particles.

3. The conductive paste ink according to claim 1, wherein the conductive particles have a spike-like morphology.

4. The conductive paste ink according to claim 1, wherein the conductive particles have a shape selected from the group consisting of a spike shape, a needle shape, a rice shape, a stick shape, a butterfly shape, and a bow tie shape.

5. The conductive paste ink according to claim 1, wherein the conductive particles have an average particle size from about 0.05 to about 10 microns.

6. The conductive paste ink according to claim 1, wherein the conductive particles are present in an amount from about 0.1 to about 5.0 weight percent of the paste ink.

7. A silver conductive paste ink comprising:
a silver conductive material;
nickel particles;
a binder; and
a solvent.

8. The conductive paste ink according to claim 7, wherein the silver conductive material comprises silver flakes.

9. The conductive paste ink according to claim 7, wherein the silver conductive material has an average particle size of from about 0.5 to about 15 microns.

10. The conductive paste ink according to claim 7, wherein the silver conductive material includes particles having an aspect ratio of at least about 30 to 1.

11. The conductive paste ink according to claim 7, wherein the silver conductive material comprises an amount of from about 50 to about 95 weight percent of the conductive paste ink.

12. The conductive paste ink according to claim 7, wherein the silver conductive material is selected from the group consisting of elemental silver, silver alloys, silver oxides, silver thiocyanates, silver cyanides, silver cyanates, silver carbonates, silver nitrates, silver nitrites, silver sulfates, silver phosphates, silver perchlorates, silver tetrafluoroborates, silver acetylacetonates, silver acetates, silver lactates, silver oxalates, and silver alloys formed from at least one metal selected from Au, Cu, Ni, Co, Pd, Pt, Ti, V, Mn, Fe, Cr, Zr, Nb, Mo, W, Ru, Cd, Ta, Re, Os, Ir, Al, Ga, Ge, In, Sn, Sb, Pb, Bi, Si, As, Hg, Sm, Eu, Th Mg, Ca, Sr and Ba.

13. A silver flake conductive paste ink, comprising:
silver flakes;
nickel particles;
a binder; and
a solvent.

14. The conductive paste ink according to claim 13, wherein the conductive paste ink has a sheet resistance of 10 mΩsq./mil or less.

15. The conductive paste ink according to claim 13, wherein the silver flakes comprise elemental silver.

16. The conductive paste ink according to claim 15, wherein the silver flakes comprise an amount of from about 50 to about 95 weight percent of the conductive paste ink.

17. The conductive paste ink according to claim 13, wherein the nickel particles are present in an amount from about 0.1 to about 5.0 weight percent of the paste ink.

18. The conductive paste ink according to claim 13, wherein the binder is present in an amount from about 0.1 to about 10.0 weight percent of the paste ink.

19. The conductive paste ink according to claim 13, wherein the binder comprises a polyvinylbutyral (PVB) terpolymer.

20. The conductive paste ink according to claim 13, wherein the solvent is present in an amount from about 5.0 to about 50.0 weight percent of the paste ink.
